(19) United States
(12) Patent Application Publication
(10) Pub. No.: US 2013/0124735 A1
(43) Pub. Date: May 16, 2013

(54) METHOD AND APPARATUS FOR PROVISIONING NETWORK ADDRESS TRANSLATOR TRAVERSAL METHODS

(71) Applicant: Samsung Electronics Co., Ltd, Gyeonggi-do (KR)

(72) Inventors: Sang-Ho Shin, Seoul (KR); Su-Bong Kim, Gyeonggi-do (KR); Hyo-Sun Shim, Gyeonggi-do (KR); Joong-Hwan Lee, Gyeonggi-do (KR); Myong-Kyun Lim, Seoul (KR); Jin-Hyeon Choi, Seoul (KR)

(73) Assignee: SAMSUNG ELECTRONICS CO., LTD, Gyeonggi-do (KR)

(21) Appl. No.: 13/674,566

(22) Filed: Nov. 12, 2012

(30) Foreign Application Priority Data
Nov. 11, 2011 (KR) 10-2011-0117587

(51) Int. Cl. G06F 15/173

(52) U.S. Cl. CPC H04L 61/2007
USPC 709/226

(57) ABSTRACT

An operating method of a device for provisioning a Network Address Translator (NAT) traversal technique includes connecting to a network, determining whether a plurality of NAT traversal techniques is operable using a server over the connected network, and storing information of an operable NAT traversal technique among the plurality of the NAT traversal techniques. Thus, the connection setup time between the devices can be shortened.

### CROSS-REFERENCE TO RELATED APPLICATION(S) AND CLAIM OF PRIORITY

The present application is related to and claims the benefit under 35 U.S.C. §119(a) to a Korean patent application filed in the Korean Intellectual Property Office on Nov. 11, 2011, and assigned Serial No. 10-2011-0117587, the entire disclosure of which is hereby incorporated by reference.

### TECHNICAL FIELD OF THE INVENTION

The present disclosure relates generally to a wireless communication system. More particularly, the present disclosure relates to a method and an apparatus for network address translator traversal.

### BACKGROUND OF THE INVENTION

In recent times, a variety of devices such as smart TVs, computers, notebooks, and smart home appliances, are used in the house. Particularly, such various devices are connected to Internet to provide diverse services to a user. To connect the various devices and the Internet, their IP addresses may be assigned.

However, users often use an IP router of a Network Address Translator (NAT) type due to the limited Internet Protocol (IP) resources and costs. With the router, a plurality of devices can access the Internet (or an IP network) using one public IP address. Thus, the router is widely used in a small office or home. The NAT interconnects a local network (or a subnet) and a global network using a private IP address, and enables communication between the local network and the global network by translating a source address/port of a packet generated in the local network.

Various techniques are devised for the direct data transmission between a first device connected to the subnet and a second device connected to another subnet (that is, data transmission between the first device and the second device without using a server). These techniques are referred to as NAT traversal techniques. The NAT traversal technique applied to the NAT of the router or the AP for building the subnet can differ.

In a related art, for the direction data transmission between the first device and the second device, the devices may attempt the data transmission using one of the NAT traversal techniques. When the connection fails, the devices connect using a relay (that is, device communication via a server) or attempt the data transmission using the several NAT traversal techniques when the direct device communication is required. When both connections fail, the devices attempt the data transmission using the relay.

To accurately determine whether the devices are connected using one NAT traversal technique, some delay (timeout) occurs. Accordingly, the connection success time varies according to network conditions. For an accurate determination, the delay can increase up to hundreds of milliseconds or seconds. It would be desirable to successfully connect the devices using one NAT traversal technique. However, when the device connection fails with all of the NAT traversal techniques, the devices may need to be connected via the relay or the server. As a result, the device connection setup time becomes longer. For example, when the connection is attempted using the conventional NAT traversal technique to download a photo from a remote server, file transmission can begin after several seconds.

As discussed above, most of the recent devices share one public IP address because of the lack of IP addresses. For doing so, the subnet is established using the AP or the router. To provide a service for sharing contents between the devices, the contents can be shared using the relay or the server. Yet, direction connection is attempted as much as possible in order to reduce server operating expenses. To raise the direction connection success, the NAT traversal techniques are used as much as possible. As more NAT traversal techniques are attempted, the connection success time is more delayed.

Hence, when the direction data communication is required between the first device connected to the subnet and the device of the other subnet, a method and an apparatus for shortening the connection setup time between the devices are required.

### SUMMARY OF THE INVENTION

To address the above-discussed deficiencies of the prior art, it is a primary aspect of the present disclosure to provide a method and an apparatus for provisioning a NAT traversal technique.

Another aspect of the present disclosure is to provide a method and an apparatus for shortening a connection setup time when subnets adopting different NAT traversal techniques are directly connected.

According to one aspect of the present disclosure, an operating method of a device for provisioning a Network Address Translator (NAT) traversal technique is provided. The method includes connecting to a network, determining whether a plurality of NAT traversal techniques is operable using a server over the connected network, and storing information of an operable NAT traversal technique of the plurality of the NAT traversal techniques.

According to another aspect of the present disclosure, a method for transmitting data between devices is provided. The method includes when a data transmission event occurs, selecting one of operable Network Address Translator (NAT) traversal techniques that are pre-stored, and transmitting data between the devices using the selected operable NAT traversal technique.

According to yet another aspect of the present disclosure, a method for transmitting data between devices is provided. The method includes when a data transmission event occurs, obtaining information associated with operable Network Address Translator (NAT) traversal techniques of a counterpart device. The method also includes determining one operable NAT traversal technique based on the operable NAT traversal technique information of the counterpart device and operable NAT traversal technique information of the device, and transmitting data between the devices using the determined operable NAT traversal technique.

According to still another aspect of the present disclosure, an apparatus for provisioning an NAT traversal technique includes a controller configured to connect to a network and determine whether a plurality of NAT traversal techniques are operable using a server over the connected network. The apparatus also includes a memory configured to store information of an operable NAT traversal technique among the plurality of the NAT traversal techniques.

According to a further aspect of the present disclosure, an apparatus for transmitting data between devices includes a controller configured to, when a data transmission event occurs, select one of a plurality of operable NAT traversal techniques that are pre-stored. The apparatus also includes an interface configured to transmit data between the devices using the selected operable NAT traversal technique.

According to a further aspect of the present disclosure, an apparatus for transmitting data between devices includes a controller configured to, when a data transmission event occurs, obtain information associated with operable NAT traversal techniques of a counterpart device, and determine one operable NAT traversal technique based on the operable NAT traversal technique information of the counterpart device and operable NAT traversal technique information of the device. The apparatus also includes an interface configured to transmit data between the devices using the determined operable NAT traversal technique.

Other aspects, advantages, and salient features of the disclosure will become apparent to those skilled in the art from the following detailed description, which, taken in conjunction with the annexed drawings, discloses exemplary embodiments of the disclosure.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A and 1B illustrate a network topology for provisioning a NAT traversal technique according to an embodiment of the present disclosure;

FIG. 2 illustrates operations of a device for determining whether the NAT traversal technique operates according to an embodiment of the present disclosure;

FIG. 3 illustrates operations of the device for directly transmitting data between devices according to one embodiment of the present disclosure;

FIG. 4 illustrates operations of the device for directly transmitting data between devices according to another embodiment of the present disclosure;

FIG. 5 illustrates Internet Gateway Device (IGD) port mapping of the NAT traversal technique according to an embodiment of the present disclosure;

FIG. 6 illustrates User Datagram Protocol (UDP) hole punching of the NAT traversal technique according to an embodiment of the present disclosure;

FIG. 7 illustrates Transport Control Protocol (TCP) hole punching of the NAT traversal technique according to an embodiment of the present disclosure;

FIG. 8 illustrates an IGD port mapping test according to an embodiment of the present disclosure;

FIG. 9 illustrates UDP hole punching failure with an AP of a specific port restricted and an AP of a normal port restricted;

FIG. 10 illustrates a UDP port mapping test according to an embodiment of the present disclosure;

FIG. 11 illustrates a TCP port mapping test according to an embodiment of the present disclosure;

FIG. 12 illustrates a simulation environment according to an embodiment of the present disclosure; and

FIG. 13 illustrates an apparatus for provisioning the NAT traversal technique according to an embodiment of the present disclosure.

Throughout the drawings, like reference numerals will be understood to refer to like parts, components and structures.

### DETAILED DESCRIPTION OF THE INVENTION

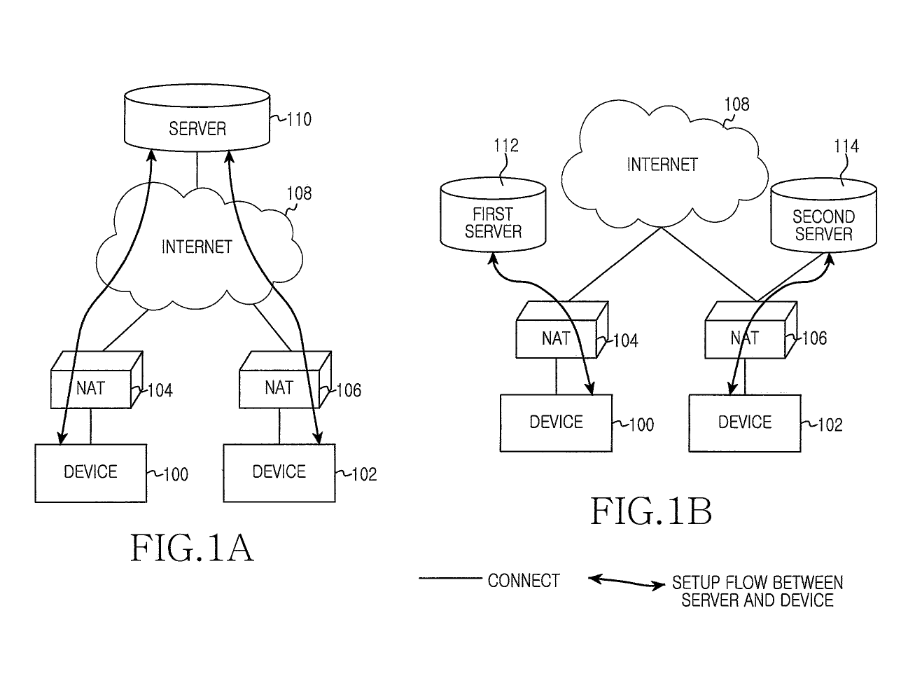

FIGS. 1A through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged network. The following description with reference to the accompanying drawings is provided to assist in a comprehensive understanding of exemplary embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of exemplary embodiments of the present disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present disclosure provide a method and an apparatus for provisioning a Network Address Translator (NAT) traversal technique.

More particularly, the present disclosure relates to a method and an apparatus for shortening a connection setup time when direction data communication is required between a first peer connected to a subnet and a second peer of another subnet established based on an Access Point (AP) or a router equipped with a Network Address Translator (NAT).

Hereinafter, a process for determining in advance which one of a plurality of NAT traversal techniques, which are well known to those skilled in the art, operates, is referred to as NAT traversal provisioning.

When it is necessary to transmit a file to and from a target device after a device predetermines the NAT traversal technique, the corresponding device can start the file transmission using the predetermined NAT traversal technique without failure. Since the file transmission is not attempted using other unavailable NAT traversal techniques, the NAT traversal provisioning, can shorten a connection setup time. The device represents a device having Internet search capability, such as a computer, smart phone, or smart TV.

FIGS. 1A and 1B depict network topology for NAT traversal technique provisioning according to an embodiment of the present disclosure.

Referring to FIGS. 1A and 1B, before the direction data transmission between devices, the devices 100 and 102 determine in advance whether the NAT traversal technique operates by signaling with servers 110, 112, and 114. In so doing, the devices 100 and 102 are connected to the Internet 108 via NATs 104 and 106. The NATs 104 and 106 translate a private IP address to a public IP address and send an outgoing packet to the Internet 108. The NATs 104 and 106 translate the public IP address to the private IP address and forward an incoming packet from the Internet 108 to the devices 100 and 102.

The NAT 104 and the device 100 build one subnet. Likewise, the NAT 106 and the device 102 build another subnet.

The first device 100 and the second device 102 are connected to the different subnets, and determine whether the NAT traversal technique operates by signaling with the corresponding server before attempting the direction data transmission, that is, at the initial phase. The NAT traversal technique employs Internet Gateway Device (IGD) port mapping, User Datagram Protocol (UDP) hole punching, Transport Control Protocol (TCP) hole punching, and the like.

The servers 110, 112, and 114 for determining whether the NAT traversal technique operates are installed outside the NATs 104 and 106. In implementations, the server can be connected to the device or the corresponding NAT over the Internet.

For example, the devices 100 and 102 are connected over the Internet 108 and determine whether the NAT traversal technique operates through the server 110 as shown in FIG. 1A. Next, the devices 100 and 102 can directly transmit data between them using the operable NAT traversal technique.

Alternatively, as shown in FIG. 1B, the servers 112 and 114 for determining whether the NAT traversal technique operates can be connected to the NATs 104 and 106 respectively. That is, the device 100 determines whether the NAT traversal technique operates through the first server 112, and the device 102 determines whether the NAT traversal technique operates through the second server 114.

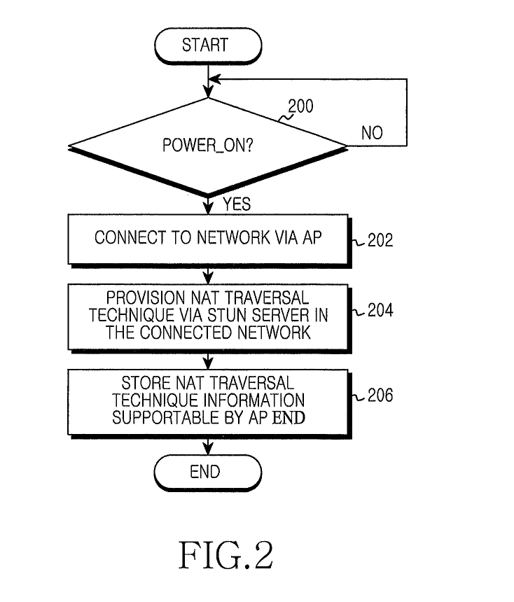

FIG. 2 illustrates operations of the device for determining whether the NAT traversal technique operates according to an embodiment of the present disclosure.

Referring to FIG. 2, when the device is turned on in block 200, the device connects to the network via an Access Point (AP) including the NAT in block 202.

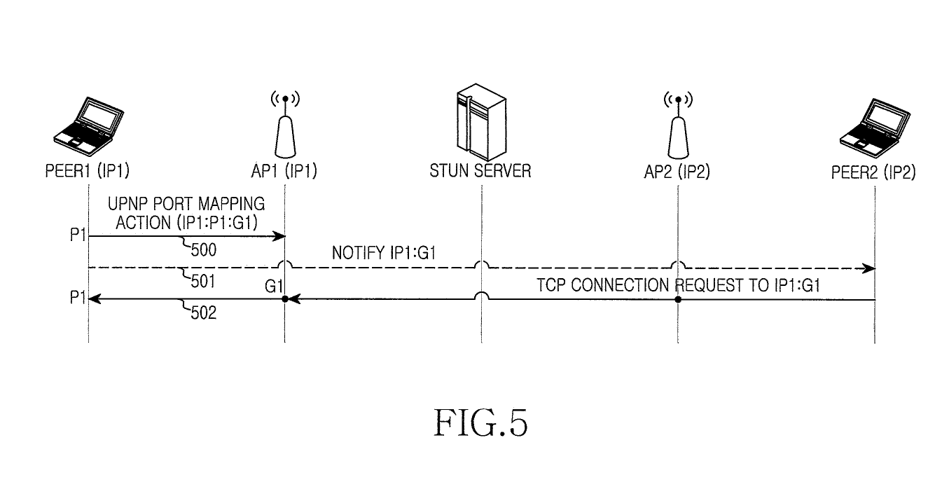

In block 204, the device predetermines which one of the IGD TCP port mapping, the UDP hole punching (including port prediction), and the TCP hole punching of the NAT traversal technique operates in its NAT by signaling (FIGS. 5 through 10) with the Simple Traversal of UDP Through NATs (STUN) servers 110, 112, and 114 of FIG. 1 designated or advertised in advance over the connected network. Hereafter, block 204 is referred to as NAT traversal technique provisioning.

In block 206, the device stores information of the operating NAT traversal technique of its connected NAT. The STUN server can also store the information of the operable NAT traversal technique of the device.

Next, the device finishes this process.

The method described above in relation with FIG. 2 under of the present invention may be provided as one or more instructions in one or more software modules, or computer programs stored in an electronic device including the device.

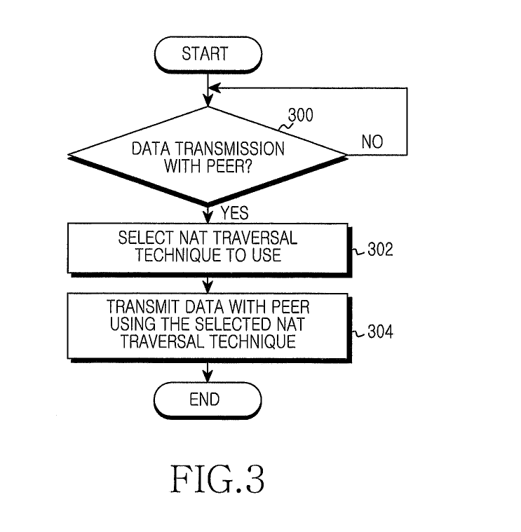

FIG. 3 illustrates operations of the device for directly transmitting data between devices according to one embodiment of the present disclosure.

When the first device attempts to directly transmit data to the second device without the server in block 300, the device selects one of the pre-stored operable NAT traversal techniques in block 302. That is, when the first device attempts the direct data transmission with the second device, it immediately attempts the communication using the NAT traversal technique determined in advance.

In block 304, the first device directly transmits data to the second device using the selected NAT traversal technique.

Next, the device finishes this process.

When the NAT traversal technique operated in the first device is the TCP port mapping and the TCP hole punching, the first device immediately attempts the communication because the communication is possible as soon as the NAT of the first device is supported regardless of property of the NAT of the second device. When the property of the NAT of the second device is the UDP hole punching, the communication is infeasible even if only the NAT of the first device is supported in a particular NAT. Hence, accuracy can be increased far more by attempting the communication after receiving the NAT traversal technique supported by the second device from the second device or the server and confirming that the UDP hole punching is supported.

The method described above in relation with FIG. 3 under of the present invention may be provided as one or more instructions in one or more software modules, or computer programs stored in an electronic device including the device.

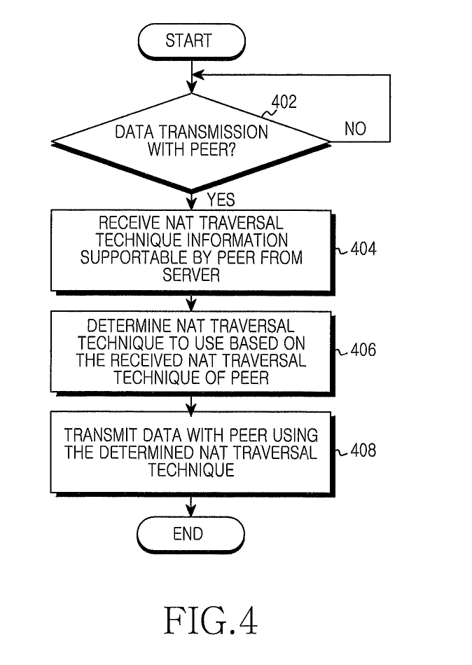

FIG. 4 illustrates operations of the device for the direct data transmission between devices according to another embodiment of the present disclosure.

When the first device attempts the data transmission with the second device in block 402, it receives from the server the information of the NAT traversal technique operating the NAT connected with the second device in block 404.

In block 406, the first device determines the NAT traversal technique to use based on the received NAT traversal technique information of the second device. For example, the first device determines the NAT traversal technique to use for the direction data transmission by comparing the received NAT traversal technique of the second device and its NAT traversal technique.

In block 408, the first device directly transmits data to the second device using the determined NAT traversal technique.

Next, the device finishes this process.

The method described above in relation with FIG. 4 under of the present invention may be provided as one or more instructions in one or more software modules, or computer programs stored in an electronic device including the device.

FIG. 5 depicts the IGD port mapping of the NAT traversal technique according to an embodiment of the present disclosure.

Referring to FIG. 5, the IGD is a Universal Plug and Play (UPnP) device which helps clients to traverse the NAT. In the recent market, most APs support the IGD. The IGD supports some UPnP actions to traverse the NAT, and port mapping action of the UPnP actions is used to generate the port mapping. For example, a peer1 sends a UPnP action command for the port mapping to set a local IP address, a local port, and a global port ip1:p1:g1 in operation 500. Next, when the peer1 communicates with a peer2, public IP address and global port IP1:g1 information of the peer1 is notified to the peer2 in operation 501. When receiving, packets from the peer2 with the global port g1, the AP1 forwards the packets with the global port g1 and the mapped IP address and local port ip1:p1 in operation 502.

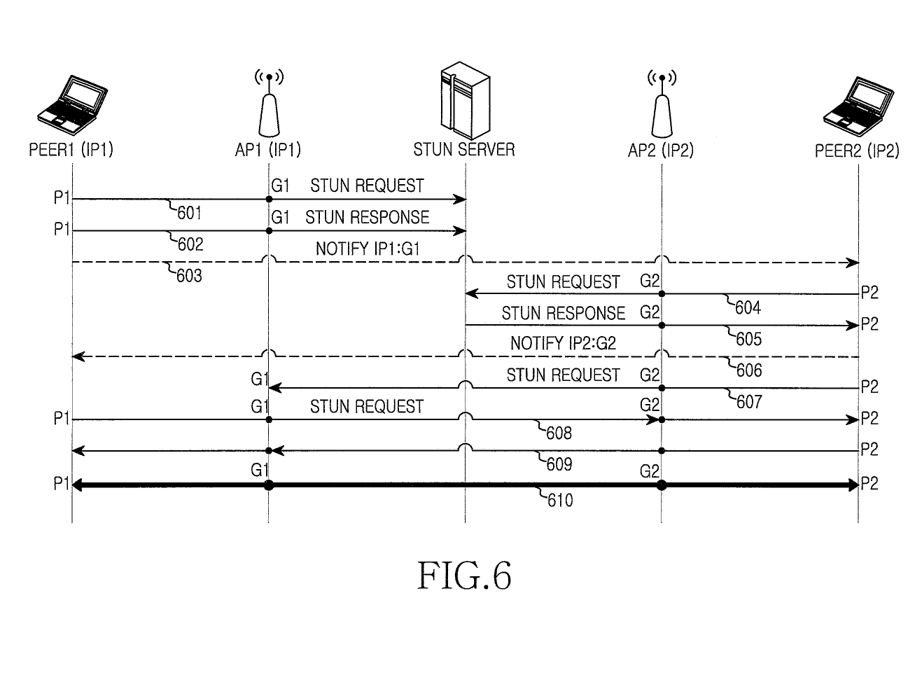

FIG. 6 depicts the UDP hole punching of the NAT traversal technique according to an embodiment of the present disclosure.

Referring to FIG. 6, the UDP hole punching is a default function of the NAT. When the client (or the device) in the NAT sends a UDP packet to the target device outside the NAT, the port mapping is generated. When the AP receives the UDP packet from the device outside the NAT with the mapped global port, the received UDP packet is forwarded to the local port of the mapped device.

When the NAT is a full cone type, the packet coming from a certain device is forwarded from the port to the local device. When internal devices transmit packets to the outside, the full cone NAT sends the packet by mapping both of the local IP address and port to the same global IP address and port. Using such NAT characteristics of the full cone type, the device can generate the mapping in advance using the server (generally, the STUN server) and receive every packet from a device outside the NAT.

For example, when the peer1 sends a STUN request to the STUN server in operation 601 and the STUN server sends a STUN response to the peer1 in operation 602, the port mapping is generated. Next, the STUN server may notify the public IP address and the global port IP1:g1 of the peer1 in operation 603. Likewise, when the peer2 sends a STUN request to the STUN server in operation 604 and the STUN server sends a STUN response to the peer2 in operation 605, the port mapping is generated. Next, the STUN server may notify the public IP address and the global port IP2:g2 of the peer2 in operation 606.

However, as the port-restricted NAT changes the port mapped to the NAT according to a destination address, it determines whether the source IP address and the port of the incoming packet are the same as the target IP address and the port. The address-restricted NAT checks the source address and does not check the port.

For example, the peer2 sends a STUN request to the peer1 through the local port p2 in operation 607. In so doing, when the AP1 receives the STUN request and the port mapping is not generated between the peer1 and the AP1, the STUN request is not forwarded from the AP1 to the peer1.

Next, the peer1 sends a STUN request to the peer2 through the local port p1 in operation 608. In so doing, when the AP2 receives the STUN request, the port mapping is generated between the peer2 and the AP2 as the result of the STUN request transmission of operation 607 and the STUN request can be forwarded from the AP2 to the peer2.

Next, the peer2 sends a STUN response of the STUN request of the peer 1, to the peer1 in operation 609.

Hence, the data can be transmitted between the peer1 and the peer2 in operation 610.

When the NAT type is the symmetric NAT, the port mapped to the NAT varies according to the address and the port of the destination. Accordingly, although the source IP address and port are the same, different global ports are assigned to the target IP address and port. Hence, the communication with other peers cannot use the global port notified by the STUN server.

Hence, when the peer is behind the symmetric NAT, the other peer should be within the address-restricted NAT or the full cone NAT to directly communicate with each other.

As stated above, the symmetric NAT generates a new port mapping for the different target IP address and port even when the source IP address and port are the same. When the new global port is assigned, some NATs increase the port number according to a rule. Once the rule is known, it is possible to predict the port to be allocated for the next UPD connection of a new target, which is hereafter referred to as UDP hole punching based on the port prediction. Its basic operations are the same as in the normal UDP hole punching. When the AP1 has the symmetric NAT increasing by 1 in the new port allocation, IP1:(g1+1) is notified instead of IP1:g1.

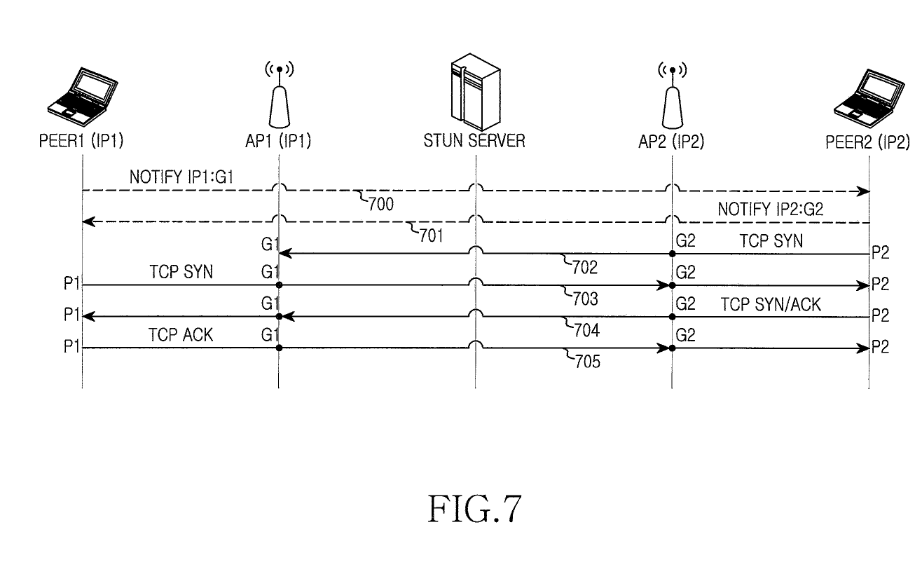

FIG. 7 depicts the TCP hole punching of the NAT traversal technique according to an embodiment of the present disclosure.

Referring to FIG. 7, the port mapping is generated not only for the UDP connection but also for the TCP connection.

For example, the public IP address and the global port IP1:g1 of the peer1 are notified to the peer2 in operation 700, and the public IP address and the global port IP2:g2 of the peer2 are notified to the peer1 in operation 701.

Based on the public IP address and the global port IP1:g1 of the peer1, the peer2 transmits a TCP SYN packet to the peer1 in operation 702. In so doing, since the port mapping is not yet generated between the peer1 and the peer2, the TCP SYN packet from the peer2 is not delivered from the AP1 to the peer 1.

Based on the public IP address and the global port IP2:g2 of the peer2, the peer1 transmits a TCP SYN packet to the peer2 in operation 703. Since the port mapping is generated between the peer2 and the AP2 in operation 702, the TCP SYN packet from the peer 1 is delivered from the AP2 to the peer2. When the peer1 transmits the TCP SYN packet to the peer2, the port mapping between the peer1 and the AP1 is generated.

Next, based on the public IP address and the global port IP1:g1 of the peer1, the peer2 transmits a TCP ACK packet (a response packet for the TCP SYN) to the peer1 in operation 704. The TCP ACK packet from the peer2 is forwarded to the local port p1 mapped to the g1.

Likewise, based on the public IP address and the global port IP2:g2 of the peer2, the peer1 transmits a TCP ACK packet (a response packet for the TCP SYN) to the peer2 in operation 705. The TCP ACK packet from the peer1 is forwarded to the local port p2 mapped to the g2.

However, most of the APs (or the NATs) examine a TCP connection negotiation state. That is, when the TCP SYN is sent to the target device via the AP, the AP predicts the TCP SYN/ACK of the next global port and rejects the TCP packet including other TCP SYN packet. Accordingly, such APs drop the second TCP SYN from the target device (the peer1) and thus the TCP connection is not established.

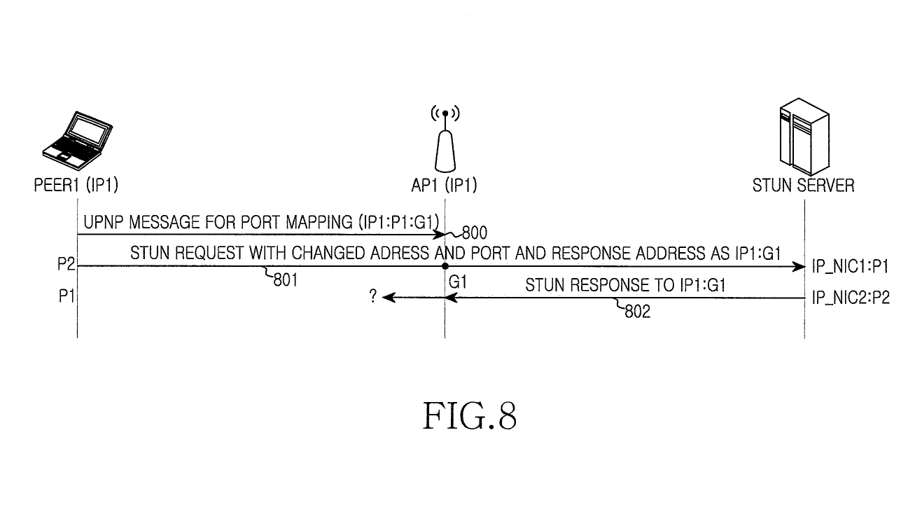

In the IGD port mapping of FIG. 5, some IGDs do not normally operate even though most of the IGDs installed to the APs support the port mapping function, or even through they advertize the UPnP action support. To avoid a waste of time in attempting the IGD port mapping of the AP, it is necessary to determine whether the port mapping function accurately operates, which is illustrated in FIG. 8.

FIG. 8 depicts an IGD port mapping test according to an embodiment of the present disclosure.

Referring to FIG. 8, the peer1 performs the UPnP port mapping by sending a UPnP port mapping action to the IGD (or the AP1) in operation 800. In so doing, the local IP address, the local port, and the global port ip1:p1:g1 are mapped between the peer1 and the AP1. The local port g1 can be mapped to the global port p using the same port number.

Next, in operation 801, the peer1 sends to the STUN sever a STUN request instructing to send a response with different destination address and port from the destination address and port of the request of the peer1, through the local port p2 instead of the local port p1.

The STUN server receives the STUN request through a first IP address and a first port IP_NIC1:P1 (hereafter, referred to a listening port).

In operation 802, the STUN server transmits a STUN response to the peer1 through a second IP address and a second port IP_NIC2:P2 (hereafter, a “response port”).

In so doing, when the port mapping is successful in the AP1, the peer1 receives the STUN response from the peer2 through the local port p1. When the peer1 cannot receive the STUN response within the timeout, this implies that the ports cannot be mapped accurately. In this situation, the AP1 determines not to support the IGD port mapping NAT traversal technique.

When both clients do not use the symmetric AP, the UDP hole punching is used to pass the NAT as explained earlier.

However, when the incoming packets are received from the outside, there exists another NAT operating with symmetric behavior. The AP generates the mapping1 using the destination port port1 as the external port and a random port as the internal port.

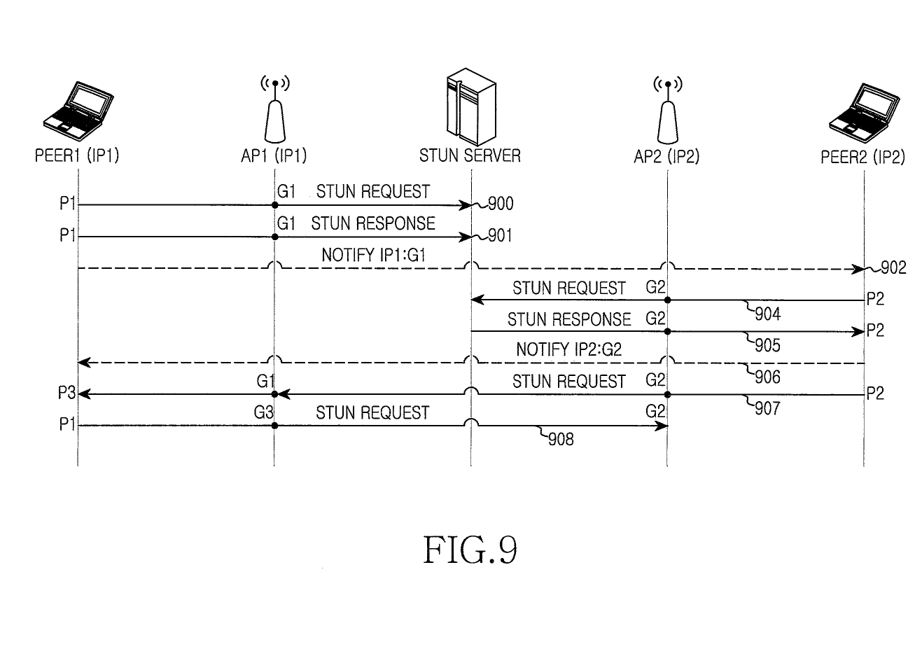

FIG. 9 depicts UDP hole punching failure with an AP of a specific port restricted and an AP of a normal port restricted.

Referring to FIG. 9, when the peer1 sends a STUN request to the STUN server in operation 900 and the STUN server sends a STUN response to the peer 1 in operation 902, the port mapping is generated. Next, the public IP address and the global port IP1:g1 of the peer1 may be notified to the peer2 in operation 903. Similarly, when the peer2 sends a STUN request to the STUN server in operation 904 and the STUN server sends a STUN response to the peer2 in operation 905, the port mapping is generated. Next, the public IP address and the global port IP2:g2 of the peer2 may be notified to the peer1 in operation 906.

When receiving the STUN request from the peer2, the AP1 generates new mapping IP2:g2:g1→ip1:p3 in operation 907. Since the STUN request is delivered to the p3 and the peer2 listens to the packet in the local port p1, the peer2 does not receive the STUN request. When the peer1 sends the STUN request to the peer2 IP2:g2, IP2:g2:g1 is already allocated to ip1:p3 and the new mapping IP2:g2:g1→ip1:p1 is allocated. When the AP2 receives the packet from IP1:g3, the AP has the port-restricted NAT and only the packet from the IP1:g1 is delivered to the ip2:p2. As a result, the packet is rejected in operation 908 and thus two peers cannot directly communicate with each other.

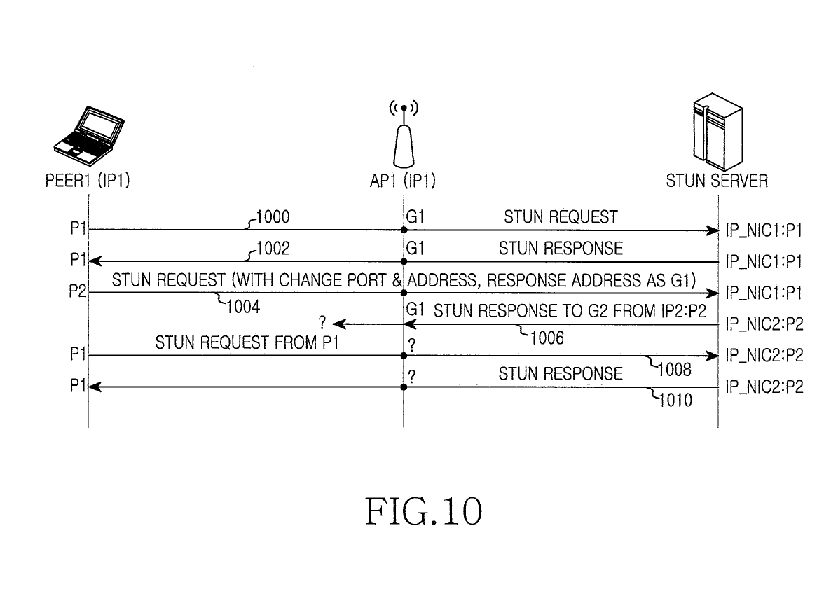

Hence, to avoid a waste of time in attempting, the UDP hole punching, the AP determines whether to generate the mapping for the incoming UDP as shown in FIG. 10.

FIG. 10 depicts a UDP port mapping test according to an embodiment of the present disclosure.

Referring to FIG. 10, by sending a STUN request to the STUN server in operation 1000 and receiving a STUN response from the STUN server in operation 1002, the peer1 obtains the mapped address IP1:g1 for ip1:p1. The ip1 is the local IP address, the p1 is the local port, the IP1 is the public IP address, and the g1 is the global port.

Next, to generate the UDP coming from the outside NAT to the IP1:g1, the peer1 sends a STUN request to the listening port IP_NIC1:P1 of the STUN server using the local port p2 in operation 1004. The STUN request includes information instructing to send the STUN response with a different address and port from the destination address and port of the request of the peer1.

In operation 1006, the STUN server sends a STUN response from other network interface IP_NIC2 to the requested address IP1:g1. When the AP1 receives the STUN response, there is no mapping for the address IP_NIC2:P2 and some APs generate the mapping for IP_NIC2:P2, g1 using a random local port. Hence, most APs discard the packet.

In operation 1008, the peer1 forwards the STUN request from the local port p1 to the STUN server IP_NIC2:P2. Upon receiving the STUN request, the AP1 attempts to generate the mapping. When the mapping for IP_NIC2:P2, g1 is generated in advance, a different global port is allocated to the local address ip1:p1. When the mapping is not generated in advance, the same port number g1 is used as the global port in the new mapping. Accordingly, it is possible to determine whether the UDP hole punching operates by comparing the mapped address of the previous STUN response and the mapped address of the current STUN address.

In operation 1010, the STUN server sends a STUN response for the STUN request received from the peer1 in operation 1008.

As mentioned in FIG. 7, only some of the APs support the TCP hole punching. Most APs drop the incoming TCP SYN packet. Even when the target port is mapped to the local port through the outgoing TCP SYN packet in advance, the APs may determine whether to support the TCP hole punching.

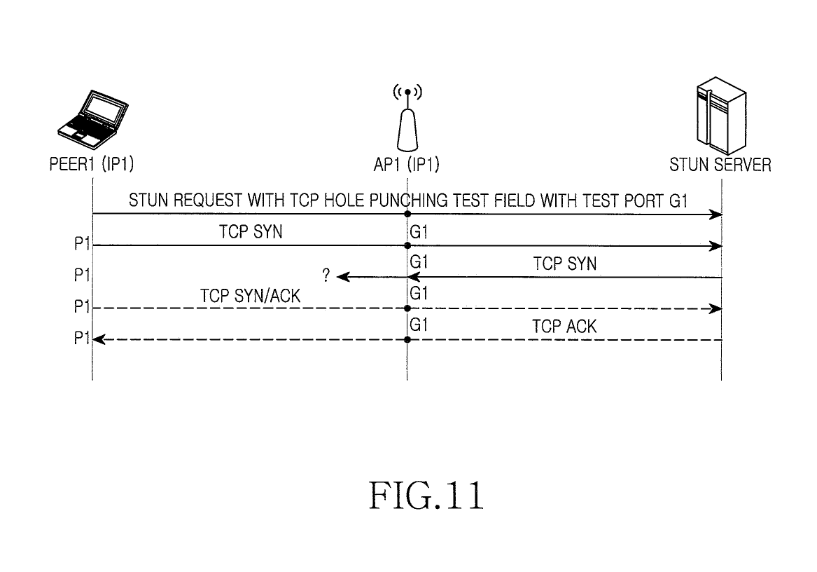

FIG. 11 depicts a TCP port mapping test according to an embodiment of the present disclosure.

Referring to FIG. 11, using the determined TCP hole punching field (for doing so, a new field may be generated) and the global test port g1, the peer1 sends a STUN request to the STUN server in operation 1100. Next, the peer1 transmits the TCP SYN packet through the local test port p1 in operation 1102. In actual implementations, it is necessary to call a function bind( ) of the local test port and then call a function connect( ) The STUN server recognizes the start of the TCP hole punching test and returns the TCP SYN packet to the global test port g1 in operation 1104. When the TCP SYN packet from the STUN port is forwarded via the AP, it implies that the AP1 supports the TCP hole punching.

Next, the peer1 transmits the TCP ACK packet for the TCP SYN packet of operation 1104 to the STUN server through the port p1 in operation 1106. The STUN server transmits the TCP ACK packet for the TCP SYN packet from the peer1 in operation 1102, to the peer1 in operation 1108. In other words, the function connect( ) finishes the rest of the TCP negotiation and successfully returns.

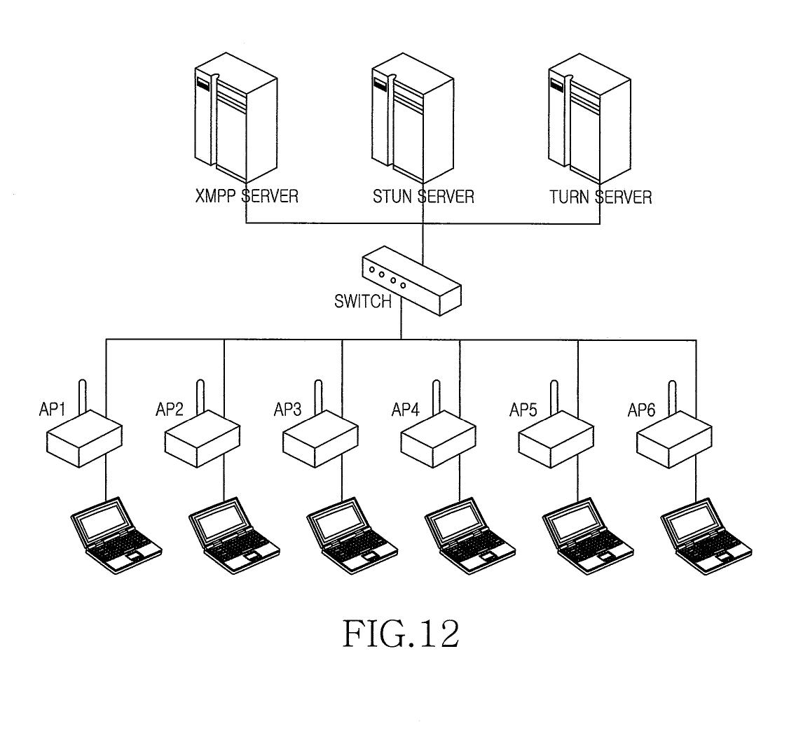

FIG. 12 depicts a simulation environment according to an embodiment of the present disclosure.

Referring to FIG. 12, six APs, AP1 through AP6, are connected to a switch, and the switch is connected to a TURN server, an Extensible Messaging and Presence Protocol (XMPP) server, and a STUN server. A device is connected to the lower end of each AP.

The APs allow the NAT traversal technique as shown in Table 1.

TABLE 1

| | AP1 | AP2 | AP3 | AP4 | AP5 | AP6 |
|---|---|---|---|---|---|---|
| NAT type | Full Cone | PortRest. | PortRest. | Symmetric | PortRest. | PortRest. |
| IGD PM | 0 | 0 | 0 | 0 | 0 | x |
| UDP HP | 0 | 0 | x | N/A | 0 | 0 |
| TCP HP | x | x | x | X | 0 | 0 |

PortRest denotes the port restricted cone NAT, Full Cone denotes the full cone NAT, and Symmetric denotes the symmetric NAT. IGD PM denotes the NAT traversal technique using the IGD port mapping, UDP HP denotes the NAT traversal technique using the UDP hole punching, and TCP denotes the NAT traversal technique using the TCP hole punching.

When the IGD operates in the simulation environment of FIG. 12, the operable NAT traversal techniques between the APs are shown in Table 2.

TABLE 2

| | AP1 | AP2 | AP3 | AP4 | AP5 | AP6 |
|---|---|---|---|---|---|---|
| AP1 | IGD PM | IGD PM | IGD PM | IGD PM | IGD PM | UDP HP |
| AP2 | — | IGD PM | IGD PM | IGD PM | IGD PM | IGD PM |
| AP3 | — | — | IGD PM | IGD PM | IGD PM | IGD PM |
| AP4 | — | — | — | IGD PM | IGD PM | IGD PM |
| AP5 | — | — | — | — | IGD PM | IGD PM |
| AP6 | — | — | — | — | — | UDP HP |

When the IGD does not operate in the simulation environment of FIG. 12, the operable NAT traversal techniques between the APs are shown in Table 3.

TABLE 3

| | AP1 | AP2 | AP3 | AP4 | AP5 | AP6 |
|---|---|---|---|---|---|---|
| AP1 | UDP HP | UDP HP | Relay | Relay | UDP HP | UDP HP |
| AP2 | — | UDP HP | Relay | Relay | UDP HP | UDP HP |
| AP3 | — | — | Relay | Relay | TCP HP | TCP HP |
| AP4 | — | — | — | Relay | TCP HP | TCP HP |
| AP5 | — | — | — | — | UDP HP | UDP HP |
| AP6 | — | — | — | — | — | UDP HP |

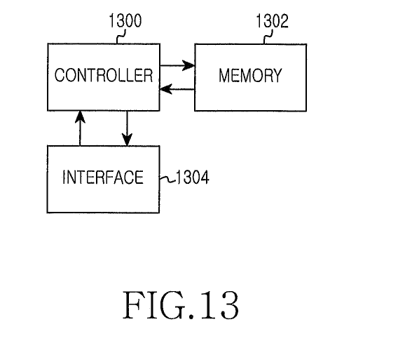

FIG. 13 depicts an apparatus for provisioning the NAT traversal technique according to an embodiment of the present disclosure.

Referring to FIG. 13, the device includes a controller 1300, a memory 1302, and an interface 1304. The device can further include additional function blocks according to its type. For example, a function block for digital TV reception (such as in a smart TV) can be added, and a function block for a camera module and voice recognition (such as in a smart phone) can be added.

The controller 1300 identifies the operable NAT traversal technique (e.g., IGD TCP port mapping, UDP hole punching (including, the port prediction), TCP hole punching, and so on) by signaling (the NAT traversal procedure of FIGS. 5 through 10) with the designated or advertized STUN server in advance, and stores the result to the memory 1302.

The memory 1302 stores the operable NAT traversal technique information provided from the controller 1300, and provides the stored operable NAT traversal technique information to the controller 1300 according to a request of the controller 1300.

The interface 1304 provides a wireless interface between the device and the AP. For example, the interface 1304 allows the communication between the device and the AP based on the Institute of Electrical and Electronics Engineers (IEEE) 802.11 standard.

The above-described methods according to the present disclosure can be implemented in hardware or software alone or in combination.

For software, a computer-readable storage medium containing one or more programs (software modules) can be provided. One or more programs stored to the computer-readable storage medium are configured for execution of one or more processors of an electronic device. One or more programs include instructions making the electronic device execute the methods according to the embodiments as described in the claims and/or the specification of the present disclosure.

Such programs (software module, software) can be stored to a random access memory, a non-volatile memory including a flash memory, a Read Only Memory (ROM), an Electrically Erasable Programmable ROM (EEPROM), a magnetic disc storage device, a compact disc ROM, Digital Versatile Discs (DVDs) or other optical storage devices, and a magnetic cassette. Alternatively, the programs can be stored to a memory combining part or all of those recording media. A plurality of memories may be equipped.

The programs can be stored to an attachable storage device of the electronic device accessible via the communication network such as Internet, Intranet, Local Area Network (LAN), Wireless LAN (WLAN), or Storage Area Network (SAN), or a communication network by combining the networks. The storage device can access the electronic device through an external port.

A separate storage device in the communication network can access a portable electronic device.

As set forth above, before the data is transmitted between the subnets using the different NAT traversal techniques, the device of the subnet provisions which NAT traversal technique operates in advance. Thus, the connection setup time between the devices can be shortened. In addition, by testing the NAT traversal technique in advance before the direction communication between the devices, the accurate NAT traversal technique can be selected and used.

Embodiments of the present invention according to the claims and description in the specification can be realized in the form of hardware, software or a combination of hardware and software.

Such software may be stored in a computer readable storage medium. The computer readable storage medium stores one or more programs (software modules), the one or more programs comprising instructions, which when executed by one or more processors in an electronic device, cause the electronic device to perform methods of the present invention.

Such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention. Embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the disclosure has been shown and described with reference to certain exemplary embodiments thereof, it will be understood by those skilled in the art that various changes in form and details may be made therein without departing from the spirit and scope of the disclosure as defined by the appended claims and their equivalents.

What is claimed is:

1. An operating method of a device for provisioning a Network Address Translator (NAT) traversal technique, comprising:
connecting to a network;
determining whether a plurality of NAT traversal techniques is operable using a server over the connected network; and
storing information of an operable NAT traversal technique among the plurality of the NAT traversal techniques.

2. The operating method of claim 1, wherein the determining of whether the plurality of the NAT traversal techniques is operable using the server comprises:
transmitting a port mapping command to an Access Point (AP) equipped with the NAT to set a local Internet Protocol (IP) address, a first local port, and a global port;
transmitting a request message to the server through a second local port, the request message comprising information instructing the server to transmit a response message of the request message with a different IP address and port; and
determining whether an Internet Gateway Device (IGD) port mapping NAT traversal technique is operable according to whether the response message is received from the server through the first local port mapped.

3. The operating method of claim 1, wherein the determining of whether the plurality of the NAT traversal techniques is operable using the server comprises:
obtaining information of the first local port, a public IP address mapped to the local IP address, and the global port by transmitting a first request message to the server and receiving a first response message from the server through the first local port;
transmitting a second request message to the server through a second local port, the second request message comprising information instructing the server to transmit a second response message with a different IP address and port;
receiving the second response message from the server through the first local port mapped; and
determining whether a User Datagram Protocol (UDP) hole punching NAT traversal technique is operable by comparing a mapped address of the first response message and a mapped address of the second response message.

4. The operating method of claim 1, wherein the determining of whether the plurality of the NAT traversal techniques is operable using the server comprises:
transmitting to the server a request message containing an indicator indicating Transport Control Protocol (TCP) hole punching and a test global port;
transmitting a TCP SYN packet to the server using the local test port; and
determining whether a (TCP) hole punching traversal technique is operable according to whether a TCP SYN packet is received from the server through the test global port.

5. The operating method of claim 1, wherein the NAT traversal technique is one of: IGD port mapping, UDP hole punching, and TCP hole punching.

6. A method for transmitting data between devices, comprising:
when a data transmission event occurs, selecting one of a plurality of operable Network Address Translator (NAT) traversal techniques that are pre-stored; and
transmitting data between the devices using the selected operable NAT traversal technique.

7. The method of claim 6, wherein the operable NAT traversal techniques that are pre-stored comprise NAT traversal techniques that have successfully passed a test of a server to determine whether the plurality of the NAT traversal techniques allow data transmission, before the data transmission.

8. The method of claim 6, wherein the NAT traversal technique is one of: Internet Gateway Device (IGD) port mapping, User Datagram Protocol (UDP) hole punching, and Transport Control Protocol (TCP) hole punching.

9. A method for transmitting data between devices, comprising:
when a data transmission event occurs, obtaining information associated with operable Network Address Translator (NAT) traversal techniques of a counterpart device;
determining one operable NAT traversal technique based on the operable NAT traversal technique information of the counterpart device and operable NAT traversal technique information of the device; and
transmitting data between the devices using the determined operable NAT traversal technique.

10. The method of claim 9, wherein the operable NAT traversal techniques comprise NAT traversal techniques that have successfully passed a test of a server to determine whether the plurality of the NAT traversal techniques allow data transmission, before the data transmission.

11. The method of claim 9, wherein the NAT traversal technique is one of: Internet Gateway Device (IGD) port mapping, User Datagram Protocol (UDP) hole punching, and Transport Control Protocol (TCP) hole punching.

12. An apparatus for provisioning a Network Address Translator (NAT) traversal technique, comprising:
a controller configured to connect to a network and determine whether a plurality of NAT traversal techniques are operable using a server over the connected network; and
a memory configured to store information of an operable NAT traversal technique among the plurality of the NAT traversal techniques.

13. The apparatus of claim 12, wherein the controller is configured to:
transmit a port mapping command to an Access Point (AP) equipped with the NAT to set a local Internet Protocol (IP) address, a first local port, and a global port;
transmit a request message to the server through a second local port, the request message comprising information instructing the server to transmit a response message of the request message with a different IP address and port; and
determine whether an Internet Gateway Device (IGD) port mapping NAT traversal technique is operable according to whether the response message is received from the server through the first local port mapped.

14. The apparatus claim 12, wherein the controller is configured to:
obtain information of the first local port, a public IP address mapped to the local IP address, and the global port by transmitting a first request message to the server and receiving a first response message from the server through the first local port;
transmit a second request message to the server through a second local port, the second request message comprising information instructing the server to transmit a second response message with different IP address and port;
receive the second response message from the server through the first local port mapped; and
determine whether a User Datagram Protocol (UDP) hole punching NAT traversal technique is operable by comparing a mapped address of the first response message and a mapped address of the second response message.

15. The apparatus of claim 12, wherein the controller is configured to:
transmit to the server a request message containing an indicator indicating Transport Control Protocol (TCP) hole punching and a test global port;
transmit a TCP SYN packet to the server using the local test port; and
determine whether a TCP hole punching traversal technique is operable according to whether a TCP SYN packet is received from the server through the test global port.

16. The apparatus of claim 12, wherein the NAT traversal technique is one of: IGD port mapping, UDP hole punching, and TCP hole punching.

17. An apparatus for transmitting data between devices, comprising:
a controller configured to, when a data transmission event occurs, select one of a plurality of operable Network Address Translator (NAT) traversal techniques that are pre-stored; and
an interface configured to transmit data between the devices using the selected operable NAT traversal technique.

18. The apparatus of claim 17, wherein the operable NAT traversal techniques that are pre-stored comprises NAT traversal techniques that have successfully passed a test of a server to determine whether the plurality of the NAT traversal techniques allow data transmission, before the data transmission.

19. An apparatus for transmitting data between devices, comprising:
a controller configured to, when a data transmission event occurs, obtain information associated with operable Network Address Translator (NAT) traversal techniques of a counterpart device, and determine one operable NAT traversal technique based on the operable NAT traversal technique information of the counterpart device and operable NAT traversal technique information of the device; and
an interface configured to transmit data between the devices using the determined operable NAT traversal technique.

20. The apparatus of claim 19, wherein the operable NAT traversal techniques comprise NAT traversal techniques that have successfully passed a test of a server to determine whether the plurality of the NAT traversal techniques allow data transmission, before the data transmission.
